(19) United States
(12) Patent Application Publication
(10) Pub. No.: US 2012/0112474 A1
(43) Pub. Date: May 10, 2012

(54) VEHICLE DOOR FIXING APPARATUS AND MOVABLE WEDGE DEVICE OF SAME

(75) Inventors: Akira MURAMATSU, Chiryu-shi (JP); Kosuke TSUKAMOTO, Chiryu-shi (JP); Yoshiki ODAKA, Kariya-shi (JP)

(73) Assignee: AISIN SEIKI KABUSHIKI KAISHA, Kariya-shi (JP)

(21) Appl. No.: 13/288,654

(22) Filed: Nov. 3, 2011

(30) Foreign Application Priority Data
Nov. 4, 2010 (JP) 2010-247113

(51) Int. Cl. E05C 1/12; E05C 17/44

(52) U.S. Cl. 292/164; 292/342

(57) ABSTRACT

A movable wedge device of a vehicle door fixing apparatus, includes a base plate fixedly attached to one of a vehicle body panel and a door panel, a movable wedge slidably provided at the base plate and pushed against a fixed wedge provided at the other one of the vehicle body panel and the door panel, a biasing member positioned between the base plate and the movable wedge and biasing the movable wedge toward the fixed wedge, a guide rail provided at one of the base plate and the movable wedge, a guide groove which is provided at the other one of the base plate and the movable wedge and with which the guide rail engages for allowing the movable wedge to slide, and an elastic member provided in a compressed state between a surface of the guide rail and a wall of the guide groove.

### CROSS REFERENCE TO RELATED APPLICATIONS

This application is based on and claims priority under 35 U.S.C. §119 to Japanese Patent Application 2010-247113, filed on Nov. 4, 2010, the entire content of which is incorporated herein by reference.

### TECHNICAL FIELD

This disclosure generally relates to a vehicle door fixing apparatus and a movable wedge device of the same.

### BACKGROUND DISCUSSION

A known vehicle door fixing apparatus is disclosed in JPH1-43298Y (hereinafter referred to as Patent reference 1). The known vehicle door fixing apparatus disclosed in the Patent reference 1 is provided with a fixed wedge including an inclined surface and fixedly attached to a door panel. The known vehicle door fixing apparatus is also provided with a movable wedge which includes an inclined surface being in contact with the inclined surface in a state where the door is closed and which is provided at a vehicle body panel in a reciprocatingly slidable manner. The movable wedge is biased by a spring so as to be pushed against the fixed wedge in a state where the door is closed, and thus the door is pushed toward a hinge of the door, and thus a backlash or a rattling of the door is restricted.

In case that the vehicle door fixing apparatus is provided with a movable member such as the movable wedge, the movable wedge may rattle and collide with members provided around the movable wedge, including the fixed wedge, thereby generating an abnormal noise in a state where the door is closed. Thus, it may be contemplated to slide the movable wedge via a rail mechanism constituted by a guide groove and a guide rail slidably engaged with the guide groove. By employing the rail mechanism, the backlash of the movable wedge may be reduced to some extent.

Even by employing the above-explained rail mechanism, however, a looseness between the guide groove and the guide rail is not completely eliminated. Accordingly, the backlash of the movable wedge is not completely eliminated, and thus the abnormal noise caused by the backlash may not be reduced adequately.

A need thus exists for a vehicle door fixing apparatus and a movable wedge device of the same, which is not susceptible to the drawback mentioned above.

### SUMMARY

According to an aspect of this disclosure, a movable wedge device of a vehicle door fixing apparatus includes a base plate configured to be fixedly attached to one of a vehicle body panel and a door panel, a movable wedge slidably provided at the base plate and configured to be provided at the one of the vehicle body panel and the door panel. The movable wedge is configured to be structured to be pushed against a fixed wedge configured to be provided at the other one of the vehicle body panel and the door panel. The movable wedge device of the vehicle door fixing apparatus also includes a biasing member provided to be positioned between the base plate and the movable wedge and biasing the movable wedge toward the fixed wedge, a guide rail provided at one of the base plate and the movable wedge, a guide groove which is provided at the other one of the base plate and the movable wedge, and with which the guide rail engages for allowing the movable wedge to slide, and an elastic member provided in a compressed state between a surface of the guide rail and a wall of the guide groove.

According to a further aspect of this disclosure, a vehicle door fixing apparatus includes a base plate configured to be provided at one of a vehicle body panel and a door panel, a fixed wedge configured to be fixedly attached to the other one of the vehicle body panel and the door panel, a movable wedge slidably provided at the base plate, a biasing member provided to be positioned between the base plate and the movable wedge and biasing the movable wedge toward the fixed wedge, a guide rail provided at one of the base plate and the movable wedge, a guide groove which is provided at the other one of the base plate and the movable wedge, and with which the guide rail engages for allowing the movable wedge to slide, and an elastic member provided in a compressed state between a surface of the guide rail and a wall of the guide groove.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross sectional view of a vehicle door fixing apparatus according to an embodiment disclosed here;

FIG. 2 is a perspective view of a movable wedge device provided at the vehicle door fixing apparatus of the embodiment;

FIG. 3 is an exploded perspective view of the movable wedge device;

FIG. 4 is a plan view of a base plate provided at the movable wedge device;

FIG. 5 is a front view of the base plate;

FIG. 6 illustrates a lower surface of the base plate;

FIG. 7 is a lateral view of the base plate;

FIG. 8 is a perspective view of the base plate;

FIG. 9 is a perspective view of the lower surface of the base plate;

FIG. 10 is a plan view of a movable wedge provided at the movable wedge device;

FIG. 11 is a lateral view of the movable wedge;

FIG. 12 is a cross sectional view of the movable wedge taken along line XII-XII in FIG. 10;

FIG. 13 is an enlarged view of a portion F indicated in FIG. 12;

FIG. 14 is a cross sectional view of the movable wedge device;

FIG. 15 is a plan view of the movable wedge device;

FIG. 16 is a perspective view illustrating a manner in which the movable wedge device is provided at a vehicle body panel;

FIG. 17 is a plan view of a fixed wedge configured to be provided at the vehicle door fixing apparatus of the embodiment;

FIG. 18 is a lateral view of the fixed wedge;

FIG. 19 is a perspective view illustrating a manner in which the fixed wedge is provided at a door panel;

FIG. 20 is a lateral view illustrating a state of the movable wedge device and the fixed wedge of the vehicle door fixing apparatus of the embodiment when the vehicle body is not deformed;

FIG. 21 is a lateral view illustrating a state of the movable wedge device and the fixed wedge of the vehicle door fixing apparatus of the embodiment when the vehicle body is deformed;

FIG. 22 is a plan view of a state of the movable wedge device of the embodiment before being assembled on the vehicle body panel;

FIG. 23 is a perspective view of the movable wedge device of the embodiment before being assembled on the vehicle body panel;

FIG. 24A is a lateral view of a resin piece provided at the movable wedge device of the embodiment;

FIG. 24B is a front view of the resin piece provided at the movable wedge device of the embodiment;

FIG. 24C is a lower surface of the resin piece provided at the movable wedge device of the embodiment;

FIG. 25 is a cross sectional view of the movable wedge device taken along line XXV-XXV in FIG. 22;

FIG. 26 is a cross sectional view of a guide groove according to a first modification of the embodiment;

FIG. 27 is a perspective view illustrating a structure of a rail mechanism according to a second modification of the embodiment;

FIG. 28 is a perspective view illustrating a structure of a rail mechanism according to a third modification of the embodiment;

FIG. 29A is a lateral view of a pin according to a fourth modification of the embodiment;

FIG. 29B is a plan view of the pin according to the fourth modification of the embodiment;

FIG. 30 is a plan view of a movable wedge device according to the fourth modification of the embodiment before being assembled on the vehicle body panel;

FIG. 31 is a perspective view of the movable wedge device according to the fourth modification of the embodiment before being assembled on the vehicle body panel;

FIG. 32 is a cross sectional view of the movable wedge device taken along line XXXII-XXXII in FIG. 30;

FIG. 33 is a plan view of a movable wedge device according to a fifth modification of the embodiment before assembled on the vehicle body panel; and

FIG. 34 is a perspective view illustrating a manner in which a movable wedge according to a sixth modification of the embodiment is provided at a vehicle door panel.

### DETAILED DESCRIPTION

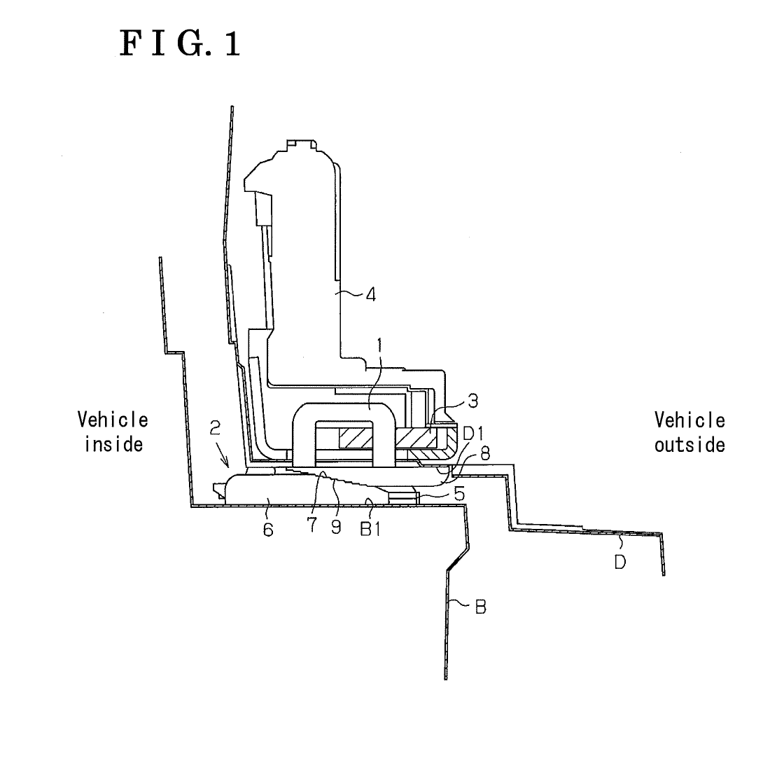

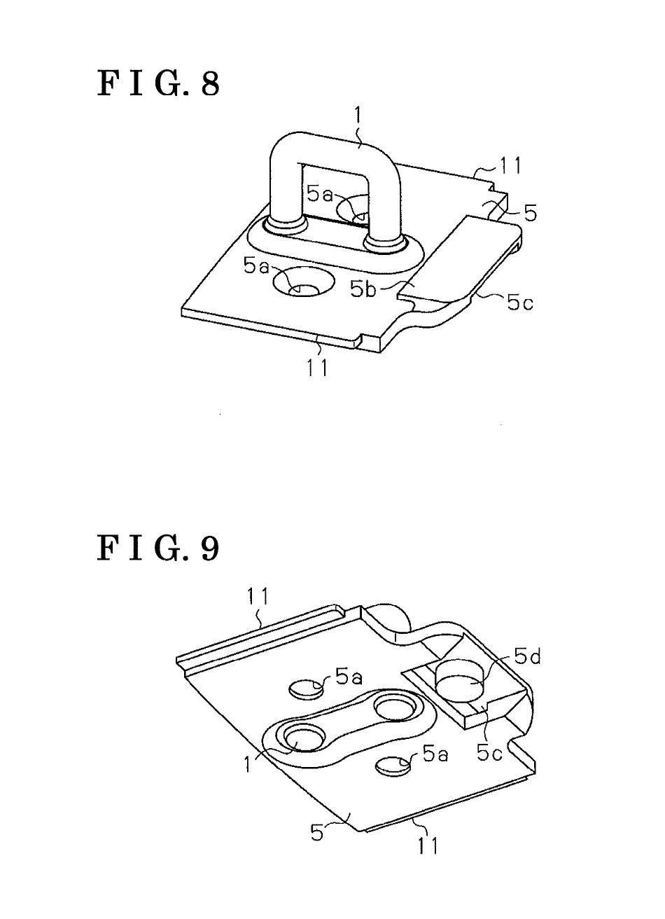

A vehicle door fixing apparatus and a movable wedge of the same, according to an embodiment will be explained with reference to FIGS. 1 to 25. First, an entire structure of the vehicle door fixing apparatus will be explained with reference to FIG. 1. As shown in FIG. 1, a movable wedge device 2 including a door lock striker 1 and a movable wedge 6 is provided at an end surface B1, which extends in a vehicle width direction and is positioned in a vicinity of the vehicle door, of a vehicle body panel B (i.e., a side member outer panel). On the other hand, a fixed wedge 8 is fixedly attached at an end surface D1, which extends in the vehicle width direction and is positioned in a vicinity of an opening of the vehicle body, of a door panel D (i.e., a door inner panel) so as to face the movable wedge device 2 in a state where the door is closed. In addition, a door lock assembly 4 including a latch 3 engaging with and disengaging from the door lock striker 1 is assembled on the door panel D together with the fixed wedge 8, the door lock assembly 4 is positioned at an opposite side of the fixed wedge 8 relative to the movable wedge device 2.

The vehicle door provided with the above-explained vehicle door fixing apparatus shown in FIG. 1 corresponds to a side door positioned at a front right side of a vehicle having an open air type body structure or a vehicle having a convertible type structure. The vehicle door provided with the above-explained vehicle door fixing apparatus is for opening and closing an opening (a door opening) provided at a side portion of the vehicle in a right/left direction in FIG. 1 (the vehicle width direction).

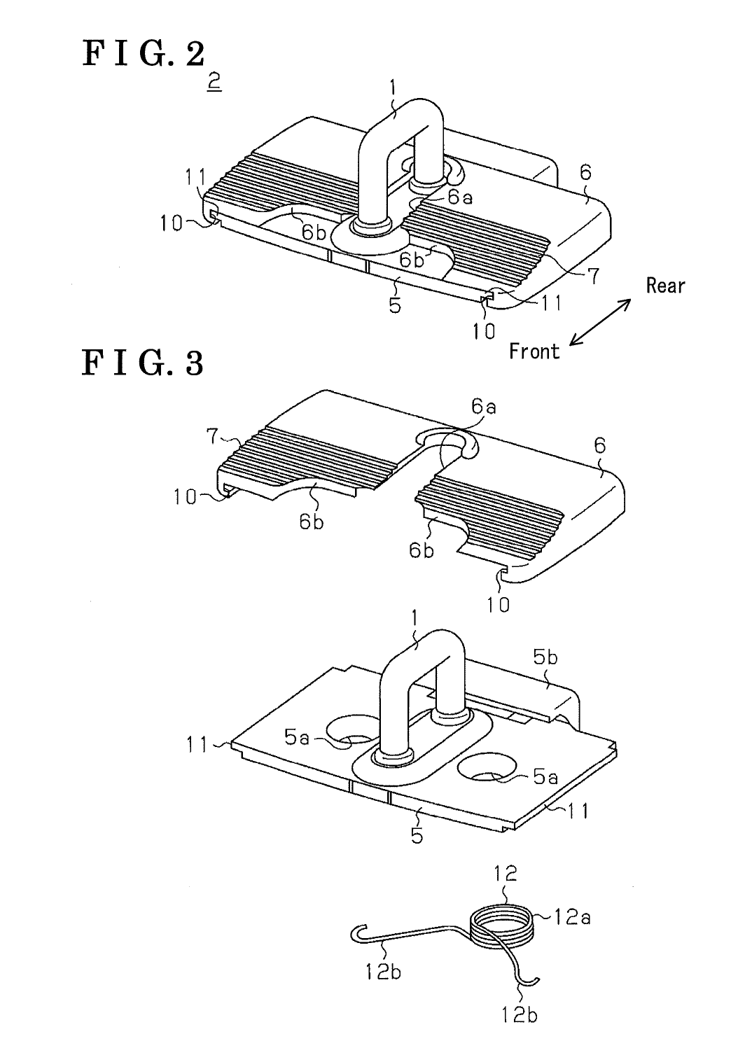

Next, the movable wedge device 2 provided at the vehicle body panel B will be explained in detail with reference to FIGS. 2 to 15. The movable wedge device 2 having a structure illustrated in FIG. 2 includes a base plate 5, the movable wedge 6, and a spring 12. The base plate 5 is formed in a substantially flat plate shape and integrally provided with the door lock striker 1. The movable wedge 6 is provided on an upper surface of the base plate 5 when viewed in FIG. 2. The spring 12 serving as a biasing member is positioned between the base plate 5 and the movable wedge 6 as shown in FIG. 3. The spring 12 includes a coil portion 12a wound in a coiled configuration and a pair of arm portions 12b, 12b each protruding from the coiled portion 12a. Hereunder, a diagonally downward left direction, a diagonally upward right direction and a diagonally lateral direction in FIG. 2 correspond to a front direction, a rear direction and a lateral direction of the movable wedge device 2, that is, of the movable wedge 6, respectively.

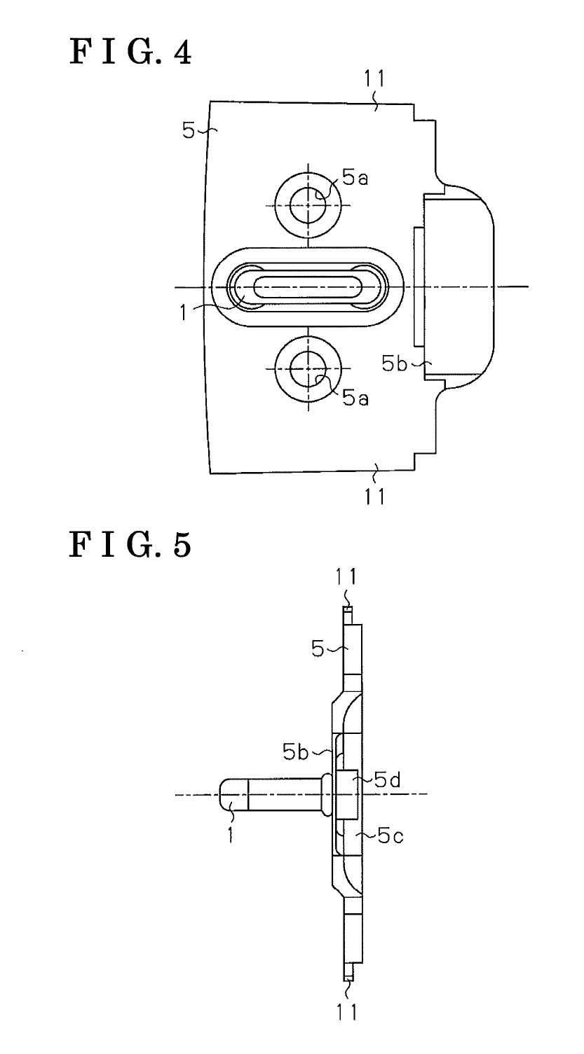

As shown in FIGS. 4 to 9, the door lock striker 1 made from a shaft bent in a substantially U-shaped form when viewed from the lateral direction of the movable wedge device 2 is integrally provided on the upper surface of the base plate 5 formed in the substantially flat plate shape. A bolt hole 5a to which a bolt for fixing the base plate 5 to the vehicle body panel B is inserted is formed on the base plate 5 at each side relative to the door lock striker 1 in the lateral direction of the movable wedge device 2. A guide rail 11 having a substantially rectangular cross-section is formed at each lateral side portion of the base plate 5 to linearly extend.

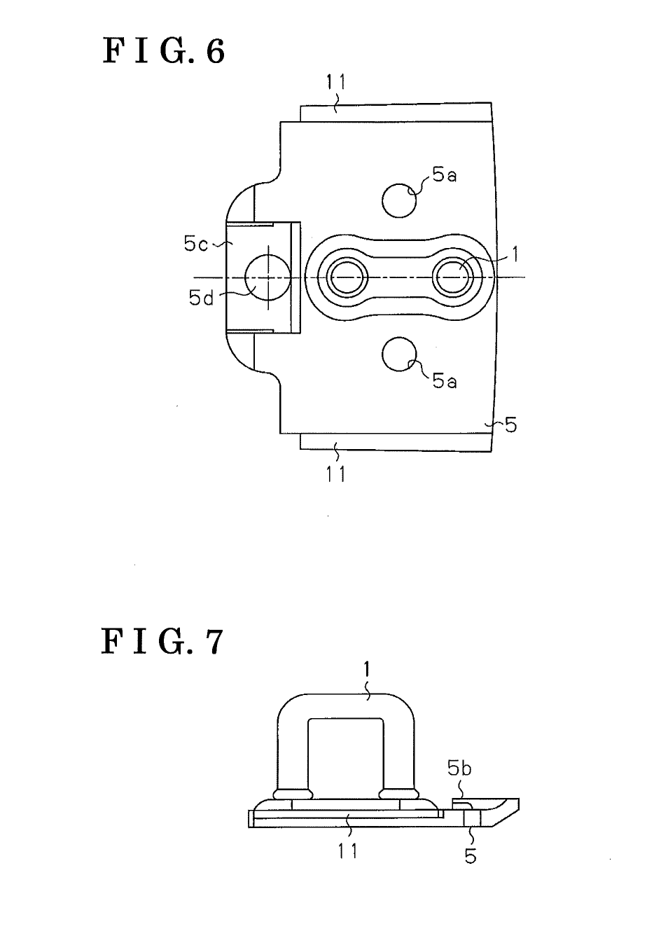

The base plate 5 further includes a protruding portion 5b formed at a rear portion of the base plate 5 and protruding upwardly. As shown in FIGS. 6 and 9, a recessed portion 5c is formed at a backside of the protruding portion 5b, that is at a portion of a lower surface of the base plate 5, to recess upwardly. A pin portion 5d having a substantially cylindrical shape is formed in a substantially central portion of the recessed portion 5c to protrude downwardly.

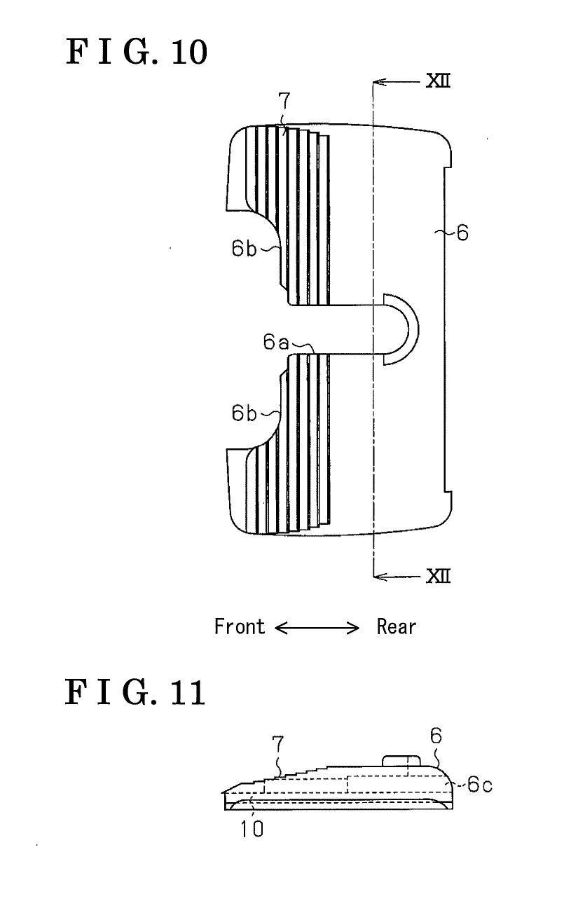

The movable wedge 6 is provided on the upper surface of the base plate 5 in a manner that the movable wedge 6 covers the upper surface of the base plate 5. As shown in FIG. 10, the movable wedge 6 is formed in a substantially rectangular shape and includes an inclined surface 7 formed at a front portion of the upper surface of the base plate 5 to be inclined relative to the upper surface of the base plate 5. Hereunder, a left direction and a right direction in FIG. 10 correspond to a front direction and a rear direction of the movable wedge 6, respectively.

A slit 6a is formed at a substantially central portion of the movable wedge 6 in a width direction of the movable wedge 6 to be cut out from the front direction toward the rear direction of the movable wedge 6. The slit 6a is provided for allowing the movable wedge 6 to slide in a reciprocating manner in the vehicle width direction relative to the door lock striker 1.

A cut-out portion 6b is formed at the front portion of the movable wedge 6 to be positioned at each lateral side relative to the slit 6a. The cut-out portion 6b is provided for allowing the bolt holes 5a formed on the base plate 5 to be exposed and thus allowing the bolts to be inserted in the bolt holes 5a in a state where the movable wedge 6 is moved in the rear direction in FIG. 10.

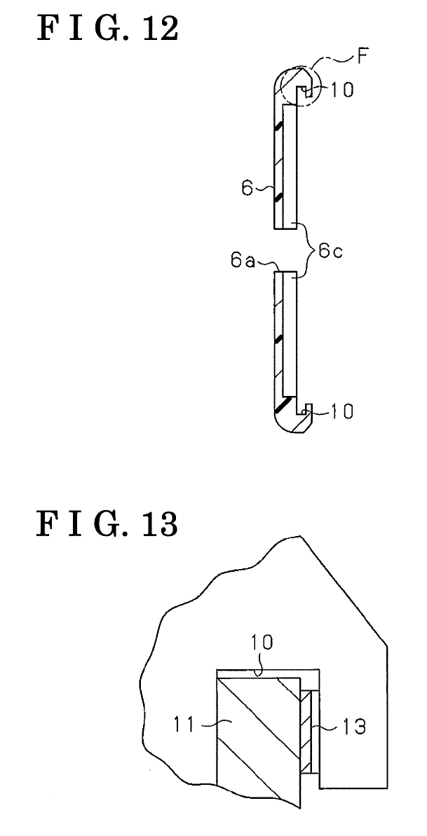

As shown in FIG. 11, the inclined surface 7 of the movable wedge 6 is formed stepwise with plural steps. A cross-section of each step of the inclined surface 7 is identical to one another. As shown in FIG. 12, the movable wedge 6 includes a pair of guide grooves 10, 10 formed at lateral side portions thereof. The guide grooves 10, 10 are arranged facing each other and extending in a sliding direction of the movable wedge 6. The guide rail 11, which is formed at each lateral side portion of the base plate 5, engages with the corresponding guide groove 10 in the slidable manner, thereby arranging the movable wedge 6 at the base plate 5 so that the movable wedge 6 is slidable relative to the base plate 5. Each of the pair of guide grooves 10, 10 is opened at a front portion and is closed at a rear portion of the movable wedge device 2.

As explained above, the movable wedge 6 is provided at the base plate 5 in the slidable manner via a rail mechanism constituted by the guide groove 10 and the guide rail 11, and thus the movable wedge 6 is slidable in the front/rear direction of the movable wedge 6 in an appropriate manner. However, a backlash of the movable wedge 6 may be caused by looseness between the guide groove 10 and the guide rail 11, thereby possibly causing an abnormal noise between the movable wedge 6 and the base plate 5 or between the movable wedge 6 and the fixed wedge 8 in a state where the door is closed.

According to the embodiment, the looseness between the guide groove 10 and the guide rail 11 is reduced by providing an elastic member in a compressed state between a surface of the guide rail 11 and a wall of the guide groove 10, thereby restricting the backlash of the movable wedge 6.

As illustrated in FIG. 13 showing an enlarged view of a portion F in FIG. 12, a leaf spring 13 (i.e., the elastic member) is provided in the compressed state between a right-side wall of the guide rail 10 and a right-side surface of the guide rail 11 when viewed in FIG. 13. The guide rail 11 is pushed by the leaf spring 13 toward a direction of a left-side wall of the guide groove 10 when viewed in FIG. 13.

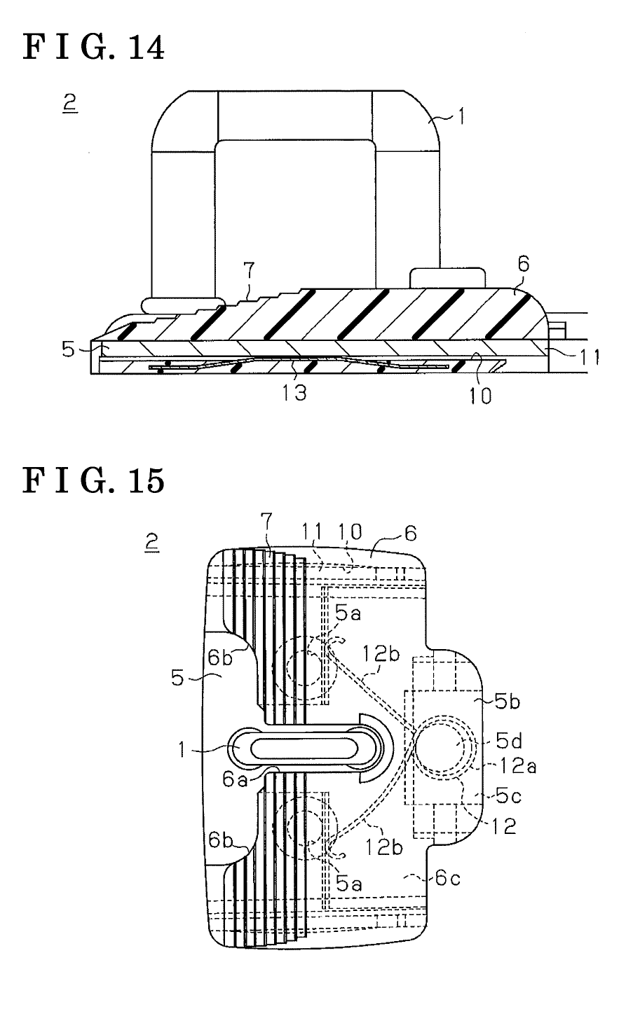

As shown in FIG. 14, the leaf spring 13 is formed in a bent shape so that a central portion thereof is curved upwardly when viewed in FIG. 14. The leaf spring 13 is insert-molded so as to be integral with the movable wedge 6.

As shown in FIG. 15, the spring 12 is provided between the base plate 5 and the movable wedge 6. The coil portion 12a of the spring 12 is accommodated in the recessed portion 5c formed on the lower surface (i.e., a backside) of the base plate 5 in a manner that the pin portion 5d is positioned in a substantially central portion of the coil portion 12a. The pair of arm portions 12b, 12b of the spring 12 is in contact with a front end surface of a recessed portion 6c formed on a lower surface (i.e., a backside) of the movable wedge 6. The protruding portion 5b formed at the rear portion of the base plate 5 functions as a stopper restricting the sliding movement of the movable wedge 6 against a biasing force of the spring 12.

As the movable wedge 6 moves in the rear direction (in the right side in FIG. 15), the pair of arm portions 12b, 12b of the spring 12 is pushed by the front end surface of the recessed portion 6c and thus an angle between the pair of arm portions 12b, 12b increases, that is, a distance between the pair of arm portions 12b, 12b increases. Thus, a torsion is generated at the coil portion 12a, thereby generating a biasing force biasing the movable wedge 6 in the forward direction (in the left side in FIG. 15). Because the spring 12 is positioned between the base plate 5 and the movable wedge 6 in a compressed state, the movable wedge 6 is always biased in the forward direction.

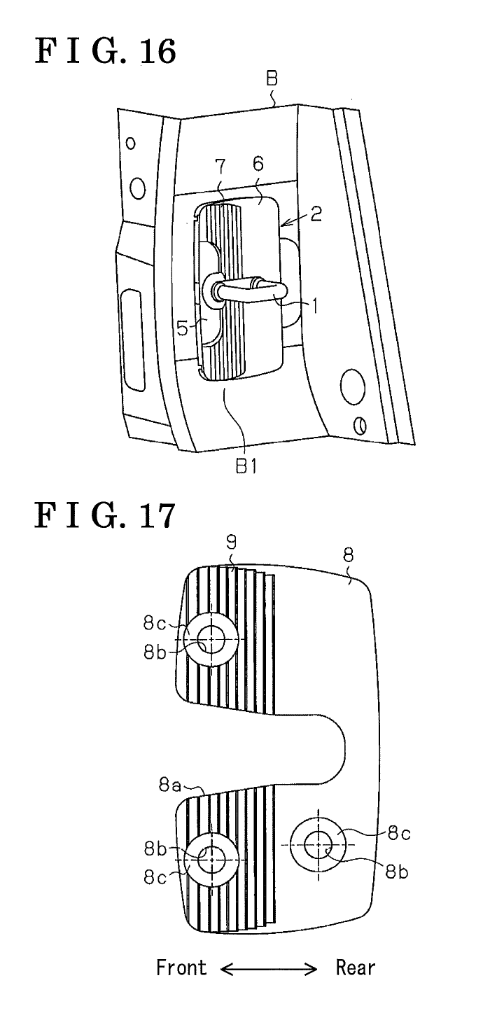

As shown in FIG. 16, the movable wedge device 2 having the above-explained structure is fixedly attached to the end surface B1, which extends in the vehicle width direction and is positioned in a vicinity of the vehicle door, of the vehicle body panel B (i.e., the side member outer panel). Next, the fixed wedge 8 provided at the door panel D will be explained in detail. Next, the fixed wedge 8, which is to be provided at the door panel D, will be explained in detail with reference to FIGS. 17 to 19.

As shown in FIG. 17, the fixed wedge 8 is formed in a substantially rectangular shape and includes an inclined surface 9 formed at a front portion of an upper surface of the fixed wedge 8 so as to be inclined relative to a lower surface of the fixed wedge 8. Hereunder, a left direction and a right direction in FIG. 17 correspond to a front direction and a rear direction of the fixed wedge 8, respectively.

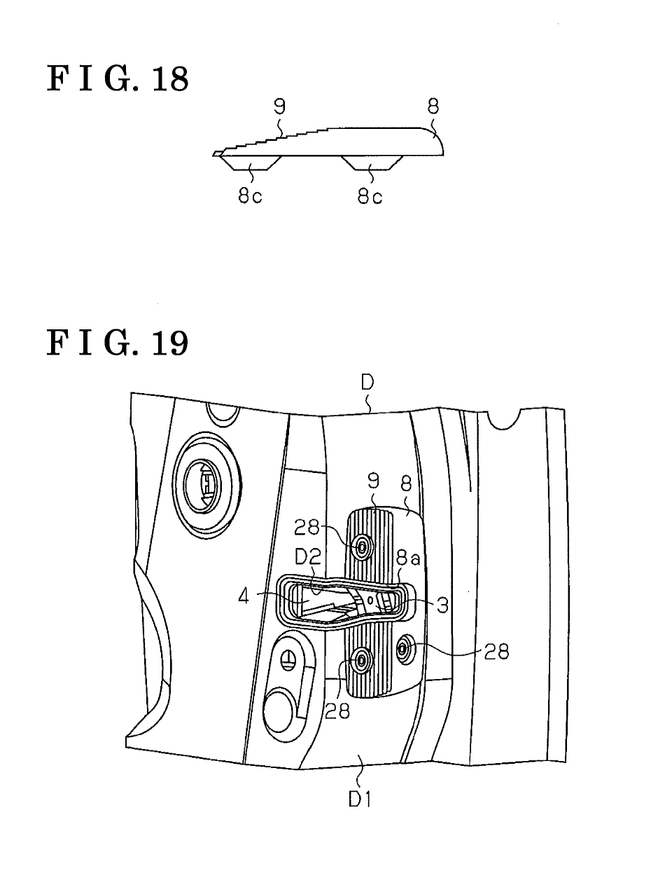

A slit 8a is formed at a substantially central portion of the fixed wedge 8 in a width direction of the fixed wedge 8 to be cut out from the front direction toward the rear direction of the fixed wedge 8. The fixed wedge 8 includes bolt holes 8b (e.g., three bolt holes) into which bolts for fixing the fixed wedge 8 to the door panel D are inserted, respectively. A tapered portion 8c serving as a bolt seat is formed on the upper surface of the fixed wedge 8, around each of the bolt holes 8b. As shown in FIG. 18, a lower surface (i.e., a backside) of the tapered portion 8c protrudes beyond the lower surface of the fixed wedge 8.

As shown in FIG. 18, the inclined surface 9 of the fixed wedge 8 is formed stepwise with plural steps. Each step of the fixed wedge 8 is formed to have an identical width in the right/left direction in FIG. 18 and an identical height in the top/bottom direction in FIG. 18 to those of each step of the inclined surface 7 formed on the movable wedge 6. Thus, the inclined surface 7 and the inclined surface 9 are engageable with each other.

As shown in FIG. 19, the fixed wedge 8 having the above-explained structure is fixedly attached to the end surface D1, which extends in the vehicle width direction and is positioned in a vicinity of the opening of the vehicle body, of the door panel D (i.e., the door inner panel) by means of bolts 28 (e.g., three bolts). As shown in FIG. 19, the slit 8a of the fixed wedge 8 is formed to match a shape of a recess D2 for receiving the striker which is formed on the door panel D, more specifically, to match the shape of a portion of the recess D2 extending in the vehicle width direction.

The fixed wedge 8 is assembled on the door panel D together with the door lock assembly 4 by means of the bolts 28 when the door lock assembly 4 is assembled on the door panel D, that is, the fixed wedge 8 is not pre-assembled on the door lock assembly 4.

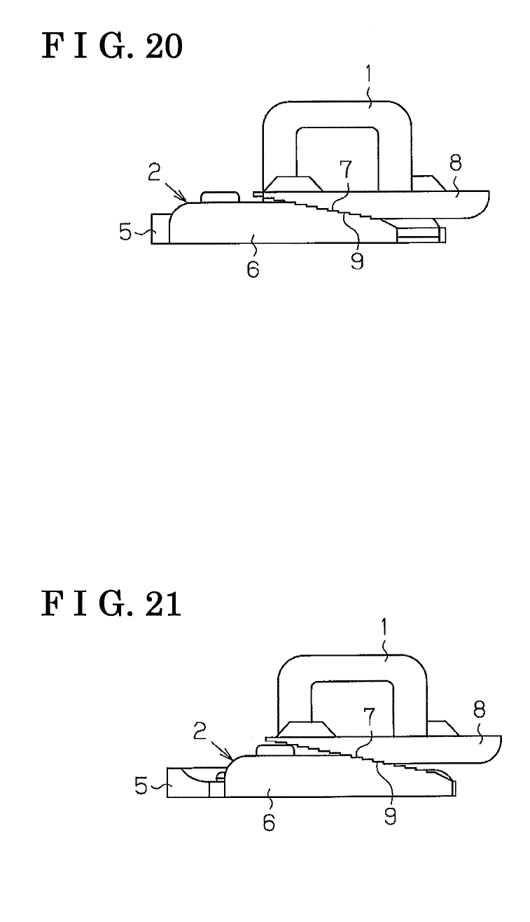

According to the vehicle door fixing apparatus including the above-explained structure, when a bending deformation occurs to the vehicle body in a right/left direction thereof while, for example, the vehicle makes a turn, the movable wedge 6 arranged at a side of the vehicle at which the vehicle body expands moves relative to the fixed wedge 8 in the right direction when viewed in FIG. 20. At this time, the movable wedge 6 in a state illustrated in FIG. 20 moves to be in a state illustrated in FIG. 21. Thus, the fixed wedge 8 moves upwardly when viewed in FIG. 21 (that is, in the front/rear direction of the vehicle when the fixed wedge 8 is assembled on the vehicle). Accordingly, a gap generated between an opening portion of the vehicle body and the vehicle door in the front/rear direction of the vehicle due to the bending deformation is reduced. At a side of the vehicle at which the vehicle body shrinks while, for example, the vehicle makes the turn, the deformation of the vehicle body may be restricted by the movable wedge device 2. Thus, according to the vehicle door fixing apparatus having the above-explained structure, a backlash of the vehicle door may be restricted and a rigidity of the vehicle body is effectively increased.

According to the above-explained structure of the vehicle door fixing apparatus, the bolt holes 5a of the base plate 5 are covered with the movable wedge 6 in a normal state, that is, in a state where the movable wedge 6 is not slid in the rear direction thereof against the biasing force of the spring 12. Thus, in order to fix the base plate 5 to the vehicle body panel B, the bolts need to be tightened while retaining the movable wedge 6 in a fully slid position against the biasing force of the spring 12 manually during the bolt tightening process, which decreases an assembling performance. Therefore, according to the embodiment, a locking member, which restricts the sliding movement of the movable wedge 6 and locks the movable wedge 6 at a position where the movable wedge 6 causes the bolt holes 5a to be exposed, is removably attached to the movable wedge device 2.

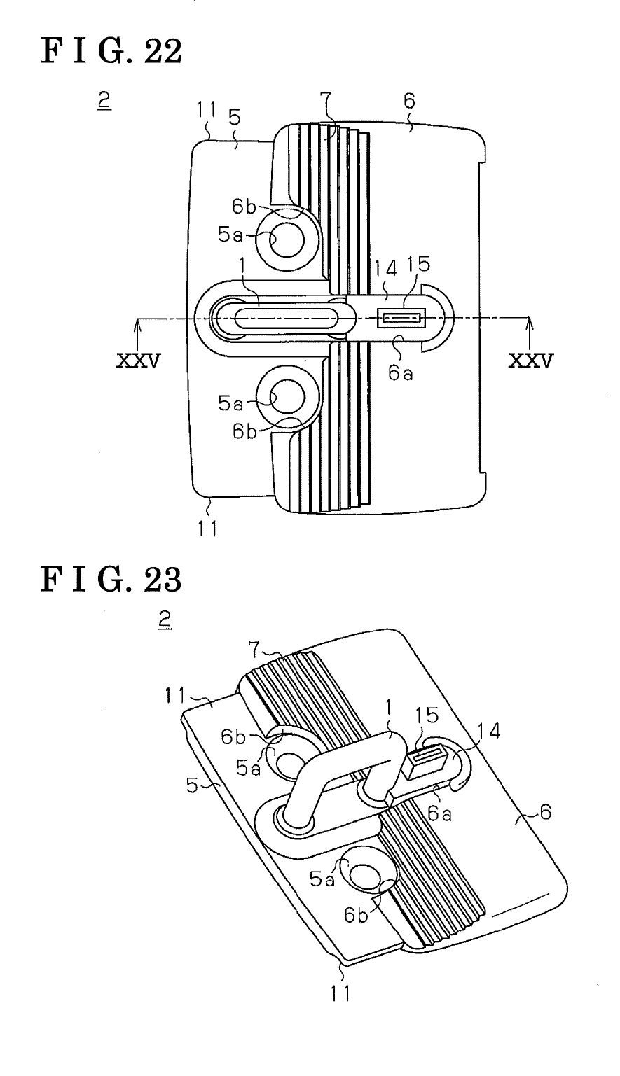

As shown in FIGS. 22 and 23, the movable wedge device 2 of the embodiment is provided with a resin piece 14 serving as the locking member restricting the sliding movement of the movable wedge 6. The resin piece 14 is configured to fit into a gap formed between an innermost portion of the slit 6a and the door lock striker 1 when the movable wedge 6 is fully slid in the rear direction thereof.

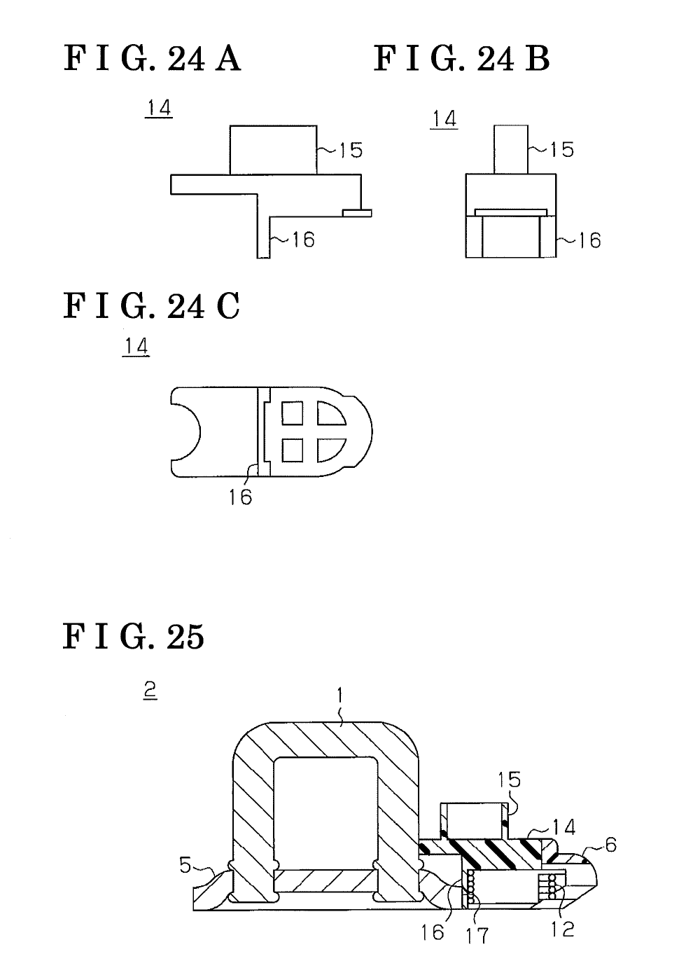

As shown in FIGS. 24A to 24C, a knob portion 15 is provided on an upper surface of the resin piece 14 so that the resin piece 14 is attached to and removed from the movable wedge device 2 by holding the knob portion 15. A protruding portion 16 is provided on a lower surface of the resin piece 14 so as to protrude downwardly. As shown in FIG. 25, the protruding portion 16 is configured to fit into a groove 17 formed on the base plate 5 in a state where the resin piece 14 is attached to the movable wedge device 2.

According to the embodiment, in a state where the resin piece 14 is attached to the movable wedge device 2 by fitting the protruding portion 16 into the groove 17, the resin piece 14 restricts the sliding movement of the movable wedge 6 so that the movable wedge 6 is locked at the position where the movable wedge 6 is fully slid in the rear direction thereof, that is, the position where the movable wedge 6 causes the bolt holes 5a of the base plate 5 to be exposed. In a state where the resin piece 14 is removed from the movable wedge device 2, the movable wedge 6, which is thus allowed to slide, is slid in the front direction by the biasing force of the spring 12. At this time, the bolt holes 5a of the base plate 5 are completely covered with the movable wedge 6. In other words, the bolt holes 5a are covered with the movable wedge 6 in a state where the resin piece 14 is not attached to the movable wedge device 2, and the bolt holes 5a are kept exposed by attaching the resin piece 14 to the movable wedge device 2.

The movable wedge device 2 of the embodiment is delivered to a vehicle assembling site with the resin piece 14 attached thereto, and thus the movable wedge 6 is restricted from sliding and is locked at the position where the bolt holes 5a to be exposed. At the vehicle assembling site, the base plate 5 is fixedly attached to the vehicle body panel B by tightening the bolts through the bolt holes 5a exposed by attaching the resin piece 14 to the movable wedge 2. After the base plate 5 is fixedly attached to the vehicle body panel B, the resin piece 14 is removed from the movable wedge device 2 so that the assembling of the movable wedge device 2 on the vehicle door fixing apparatus is completed. In other words, according to the embodiment, the movable wedge device 2 is assembled on the vehicle door fixing apparatus through the following processes A to C.

A. A process in which the resin piece 14 restricting the sliding movement of the movable edge 6 to lock the movable wedge 6 at the position where the bolt holes 5a are exposed is attached to the movable wedge device 2. B. A process in which the base plate 5 is fixedly attached to the vehicle body panel B by tightening the bolts through the bolt holes 5a which are exposed by attaching the resin piece 14 to the movable wedge 2.

C. A process in which the resin piece 14 is removed from the movable wedge device 2 after the base plate 5 is fixedly attached to the vehicle body panel B. As explained above, according to the embodiment, the following effects and advantages may be obtained. (1) The vehicle door fixing apparatus of the embodiment includes the fixed wedge 8 fixedly attached to the door panel D, the base plate 5 fixedly attached to the vehicle body panel B, the movable wedge 6 provided at the base plate 5 in the slidable manner and the spring 12 serving as the biasing member biasing the movable wedge 6 toward the fixed wedge 8. The guide rail 11 formed at the base plate 5 engages with the guide groove 10 formed at the movable wedge 6 in a manner that the guide rail 11 and the guide groove 10 slide relative to each other, thereby allowing the movable wedge 6 to slide. According to the vehicle door fixing apparatus of the embodiment, the leaf spring 13 is provided in the compressed state between the wall of the guide groove 10 and the surface of the guide rail 11. According to the embodiment, the leaf spring 13 pushes the surface of the guide rail 11 against the wall of the guide groove 10. Thus, the looseness between the guide groove 10 and the guide rail 11 is reduced, thereby restricting the backlash of the movable wedge 6. Consequently, according to the embodiment, the backlash of the movable wedge 6 may be restricted and an abnormal noise caused by the backlash may be appropriately restricted.

(2) According to the embodiment, the leaf spring 13 made from metal is insert-molded to the movable wedge 6 made of resin. Thus, the leaf spring 13 made from metal may be provided at the movable wedge 6 made of resin in a simple and accurate manner.

(3) According to the embodiment, a surface of the inclined surface 7 of the movable wedge 6 is coated with layers of elastic material, for example, silicon rubber but not limited thereto. Thus, in case the inclined surface 7 of the movable wedge 6 collides with the inclined surface 9 of the fixed wedge 8 due to a vibration of the vehicle body, the elastic material may absorb the energy of an impact between the inclined surface 7 and the inclined surface 9, and thus an occurrence of a high-volume abnormal noise may be restricted.

(4) According to the embodiment, the resin piece 14 as the locking member, which restricts the sliding movement of the movable wedge 6 and locks the movable wedge 6 at the position where the movable wedge 6 causes the bolt hole 5a to be exposed, is removably attached to the movable wedge device 2. Thus, in a state where the resin piece 14 is attached to the movable wedge device 2, the bolts may be tightened without manually sliding the movable wedge 6 against the biasing force of the spring 12. By removing the resin piece 14 from the movable wedge device 2 after the bolts are tightened, the movable wedge device 2 functions properly. Consequently, according to the embodiment, a favorable assembling performance of the movable wedge device 2, which includes the movable wedge 6 for restricting a backlash of the door and which is provided at the vehicle door fixing apparatus, is ensured.

(5) According to an assembling method of the embodiment, the movable wedge device 2 is assembled on the vehicle door fixing apparatus through the process in which the resin piece 14 restricting the sliding movement of the movable edge 6 so that the movable wedge 6 is locked at the position where the bolt holes 5a are exposed is attached to the movable wedge device 2, the process in which the base plate 5 is fixedly attached to the vehicle body panel B by tightening the bolts through the bolt holes 5a, which are exposed by attaching the resin piece 14 to the movable wedge device 2, and the process in which the resin piece 14 is removed from the movable wedge device 2 after the base plate 5 is fixedly attached to the vehicle body panel B. Thus, the bolts may be tightened without manually sliding the movable wedge 6 against the biasing force of the spring 12, thereby ensuring the favorable assembling performance of the movable wedge device 2, which includes the movable wedge 6 for restricting the backlash of the door and which is provided at the vehicle door fixing apparatus.

(6) According to the embodiment, the resin piece 14 fits into the gap formed between the innermost portion of the slit 6a and the door lock striker 1 when the movable wedge 6 is displaced to the position where the movable wedge 6 causes the bolt holes 5a to be exposed. The resin piece 14, which is fitted into the gap in the above-explained state, restricts the sliding movement of the movable wedge 6. Thus, the sliding movement of the movable wedge 6 may be reliably restricted by means of a member having a relatively simple configuration.

(7) According to the embodiment, the protruding portion 16 is provided on the lower surface of the resin piece 14 so as to protrude downwardly and the groove 17 for accepting the protruding portion 16 is formed on the base plate 5. Thus, the resin piece 14 may be attached to the movable wedge device 2 in a reliable and stable manner.

(8) According to the embodiment, the knob portion 15 is provided on the upper surface of the resin piece 14. Thus, the resin piece 14 may be held reliably, and attached to and removed from the movable wedge device 2 easily.

(9) According to the embodiment, the movable wedge 6 may be assembled on the vehicle body panel B via the base plate 5 at the same time when the door lock striker 1 is assembled on the vehicle body panel B. The fixed wedge 8 may be assembled on the door panel D at the same time when the door lock assembly 4 is assembled on the door panel D. Thus, man-hours for assembling the vehicle door fixing apparatus on the vehicle may be reduced, thereby improving the working performance for the assembly.

(10) According to the embodiment, plural steps are formed on the inclined surface 7 of the movable wedge 6 and on the inclined surface 9 of the fixed wedge 8 in a manner that the plural steps of the inclined surface 7 and the plural steps of the inclined surface 9 are engageable with each other. Thus, an occurrence of slippage between the inclined surface 7 and the inclined surface 9 may be restricted without reducing an inclination angle of the inclined surfaces 7 and 9 to be smaller than an angle of friction thereof, and thus the inclined surfaces 7 and 9 may be downsized.

Variations and changes may be made to the embodiment as follows. Modifications of the leaf spring 13 will be explained as follows. As explained above, according to the embodiment, the looseness between the guide rail 11 and the guide groove 10 is reduced by providing the leaf spring 13 in the compressed state between the wall of the guide groove 10 and the surface of the guide rail 11, thereby restricting the backlash from occurring to the movable wedge 6. In the embodiment, the leaf spring 13 that is made from metal and is insert-molded to be integral with the movable wedge 6 is used as the elastic member.

However, another member than the leaf spring 13 made from metal may restrict the backlash of the movable wedge 6 as long as the another member is provided between the wall of the guide groove 10 and the surface of the guide rail 11 in the compressed state.

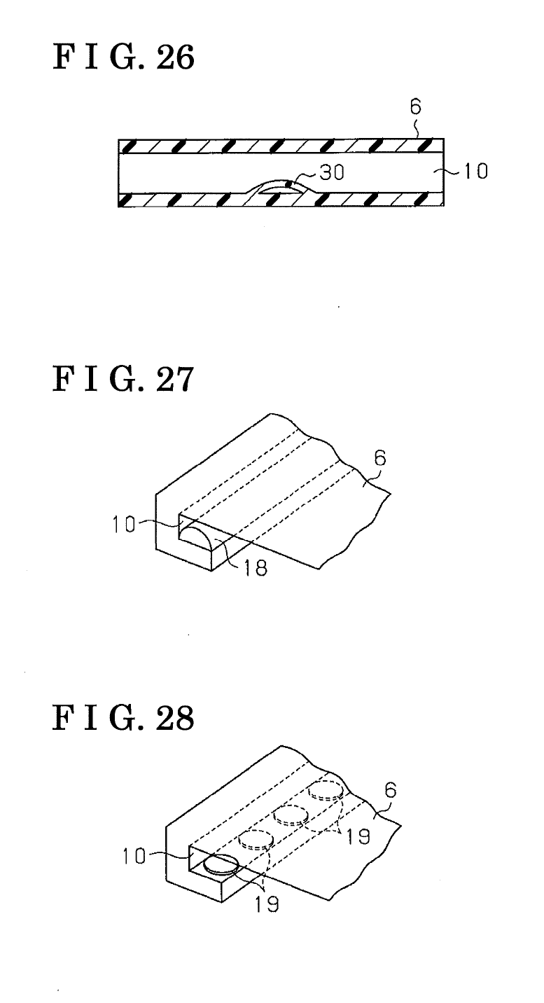

For example, as shown in FIG. 26, according to a first modification of the embodiment, a leaf spring 30 (i.e., the elastic member) made of resin may restrict the backlash of the movable wedge 6. The leaf spring 30 is formed during a molding process of the movable wedge 6 at a lower wall of the guide groove 10, when viewed in FIG. 26, so as to be integral with the movable wedge 6. The guide rail 11 is pushed by the leaf spring 30, similarly to the way the guide rail 11 is pushed by the leaf spring 13 made from metal, toward a direction of an upper wall, when viewed in FIG. 26, of the guide groove 10. Thus, the looseness between the guide rail 11 and the guide groove 10 is reduced, and thus the backlash of the movable wedge 6 may be restricted, thereby appropriately restricting the occurrence of the abnormal noise caused by the backlash. Here, the leaf spring 30 made of resin is formed to be integral with the movable wedge 6 made of resin, however, the leaf spring 30 may be formed separately from the movable wedge 6.

As shown in FIG. 27, according to a second modification of the embodiment, a protrusion 18 (i.e., the elastic member) may also restrict the backlash of the movable wedge 6 in a manner similar as described above. The protrusion 18, which is formed to have a substantially semicircular cross-section and to extend in a direction in which the guide groove 10 extends, is fixed to the lower wall, when viewed in FIG. 27, of the guide groove 10. The protrusion 18 is formed so that a height thereof is greater than a gap formed between the surface of the guide rail 11 and the wall of the guide groove 10, and so that the protrusion 18 is provided between the surface of the guide rail 11 and the wall of the guide groove 10 in the compressed state. The protrusion 18 is made of elastic material, for example, silicon rubber but is not limited thereto.

The above-explained shape of the protrusion 18 is not limited thereto and may be appropriately changed. For example, as shown in FIG. 28, according to a third modification of the embodiment, a protrusion 19 (i.e., the elastic member) formed in a substantially cylindrical shape is provided at the groove 10 in a manner that plural protrusions 19 are arranged on the groove 10 with a constant interval thereamong along the direction in which the guide groove 10 extends. Here, the protrusion 18, 19 is provided at the wall of the guide groove 10, however, the protrusion 18, 19 made of the elastic material may be provided at the surface of the guide rail 11 by means of an outsert-molding or another method.

Modifications of the resin piece 14 will be explained as follows. As explained above, according to the embodiment, the resin piece 14, which restricts the sliding movement of the movable wedge 6 so that the movable wedge 6 is locked at the position where the bolt holes 5a of the base plate 5 are exposed, is removably attached to the movable wedge device 2, thereby facilitating an assembling work for bolting the base plate 5 on the vehicle body panel B. However, another member may be used instead of the resin piece 14 as long as the another member is configured to restrict the sliding movement of the movable wedge 6 so that the movable wedge 6 is locked at the position where the movable wedge 6 causes the bolt holes 5a of the base plate 5 to be exposed.

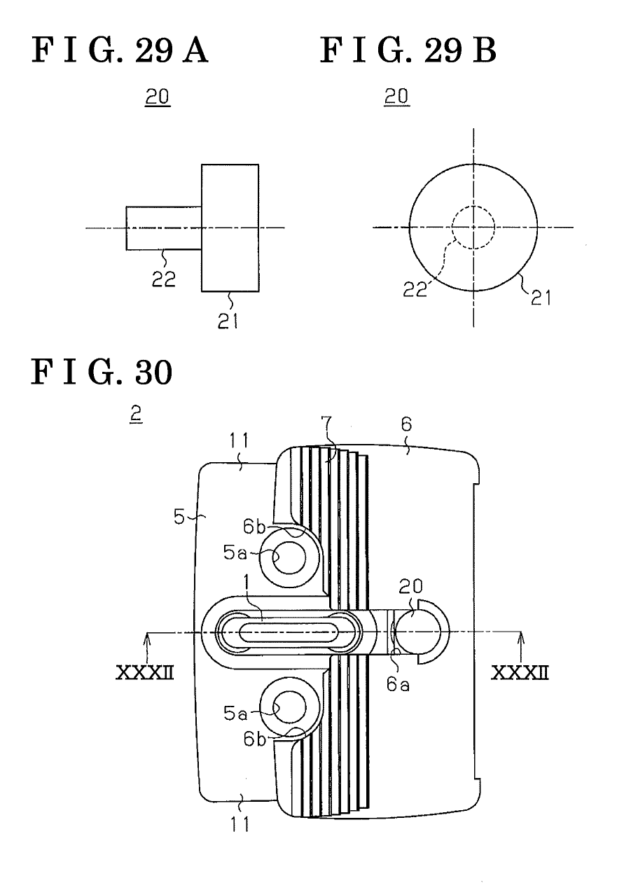

For example, as shown in FIGS. 29A and 29B, a pin 20 according to a fourth modification of the embodiment may restrict the sliding movement of the movable wedge 6. The pin 20 includes a large diameter portion 21 having a cylindrical shape and a small diameter portion 22 having a cylindrical shape.

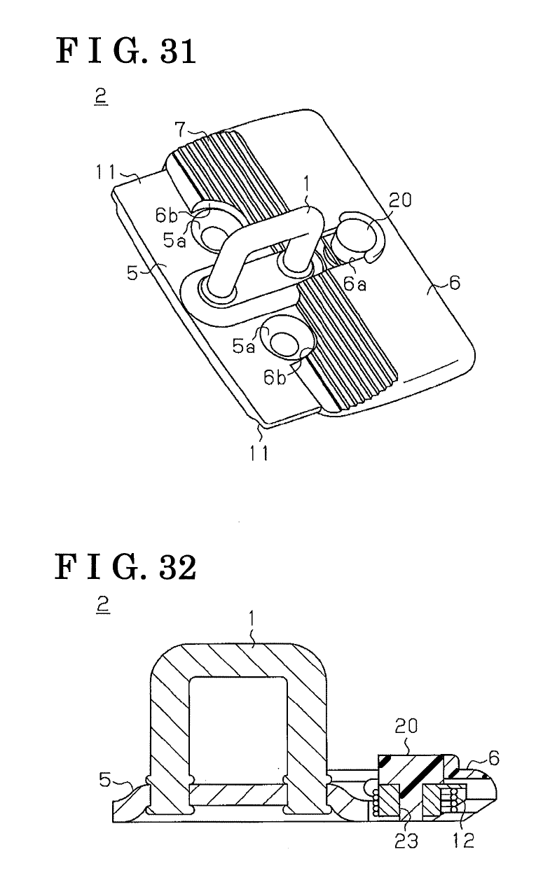

As shown in FIGS. 30 and 31, in a state where the pin 20 is attached to the movable wedge device 2, the large diameter portion 21 is in contact with the innermost portion of the slit 6a formed at the movable wedge 6, thereby restricting the sliding movement of the movable wedge 6 so that the movable wedge 6 is locked at the position where the movable wedge 6 is fully slid in the rear direction, that is, where the bolt holes 5a of the base plate 5 are exposed. As shown in FIG. 32, the pin 20 is attached to the base plate 5 by fitting the small diameter portion 22 into a hole 23 formed on the protruding portion 5b provided at the rear portion of the base plate 5.

In the foregoing explanation, the pin 20 made of resin or the resin piece 14 is used as the locking member restricting the sliding movement of the movable wedge 6 and locking the movable wedge 6 at the position where the movable wedge 6 causes the bolt holes 5a to be exposed. However, the pin 20 and the resin piece 14 may be made from metal or other material.

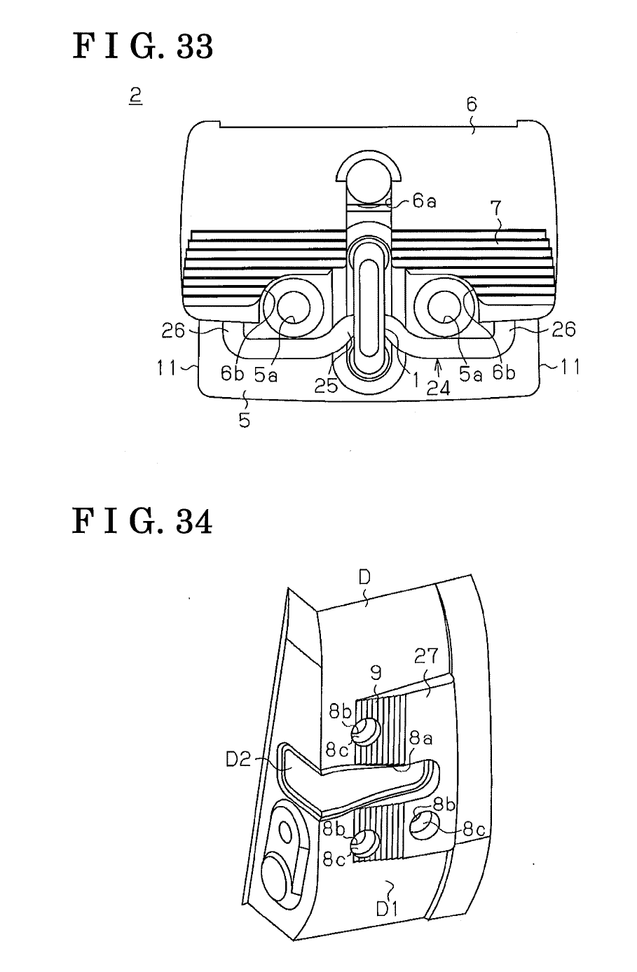

For example, as shown in FIG. 33, a latch member 24 (i.e., serving as the locking member) according to a fifth modification of the embodiment may restrict the sliding movement of the movable wedge 6 and lock the movable wedge 6 at the position where the bolt holes 5a are exposed. The latch member 24 is attached to the movable wedge device 2 so that a middle portion 25 of the latch member 24 is in contact with the door lock striker 1 and that end portions 26, 26 of the latch member 24 in a lengthwise direction thereof are in contact with a front end face of the movable wedge 6. In a state where the latch member 24 having the above-explained configuration is attached to the movable wedge device 2, the latch member 24 is positioned to be sandwiched between the door lock striker 1 and the front end face of the movable wedge 6, and thus the sliding movement of the movable wedge 6 is restricted and the movable wedge 6 is locked at the position where the bolt holes 5a of the base plate 5 are exposed.

As explained above, another member may be used as long as the another member is configured to restrict the sliding movement of the movable wedge 6 and to lock the movable wedge 6 at the position where the movable wedge 6 causes the bolt holes 5a to be exposed. Other modifications will be explained as follows. According to the embodiment, the protruding portion 16 is provided on the lower surface of the resin piece 14 so as to protrude downwardly and the groove 17, into which the protruding portion 16 is fitted, is formed on the base plate 5. However, the resin piece 14 and the base plate 5 may be configured without including the protruding portion 16 and the groove 17, respectively as long as the resin piece 14 is attached to the movable wedge device 2 in the reliable and stable manner.

The configurations of the leaf springs 13, 30 of the embodiment are not limited thereto and appropriate variations and changes may be made. The leaf springs 13, 30 may have other configurations as long as the leaf spring 13, 30 is configured to push the guide rail 11 toward the wall of the guide groove 10.

According to the embodiment, the leaf spring 13, 30 is provided on the wall of the guide groove 10, however, the leaf spring 13, 30 may be provided on the surface of the guide rail 11.

According to the embodiment, the leaf spring 13 made from metal is insert-molded to the movable wedge 6 made of resin, however, a manner in which the leaf spring 13 is provided is not limited thereto. The leaf spring 13 may be provided in another appropriate manner.

According to the embodiment, the movable wedge 6 is biased by the spring 12. The configuration of the spring 12 is not limited to that shown in FIG. 3 and appropriate variations and changes may be made. In addition, another elastic member than the spring may be used for biasing the movable wedge 6.

According to the embodiment, the door lock striker 1 is provided integrally with the movable wedge device 2 constituted by the base plate 5, the movable wedge 6 and the spring 12, however, the door lock striker 1 may be provided separately from the movable wedge device 2.

According to the embodiment, each of the inclined surface 7 of the movable wedge 6 and the inclined surface 9 of the fixed wedge 8 is formed stepwise, however, each of the inclined surfaces 7, 8 may be formed in a flat surface or a curved surface not including steps.

According to the embodiment, the fixed wedge 8 is fixedly attached to the door panel D by means of the bolts. However, according to a sixth modification of the embodiment, a fixed wedge 27 may be integrally provided at the door panel D as shown in FIG. 34.

According to the embodiment, the movable wedge 6 is provided at the vehicle body panel B and the fixed wedge 8 is provided at the door panel D, however, the movable wedge 6 may be provided at the door panel D and the fixed wedge 8 may be provided at the vehicle body panel B. In this case, the fixed wedge 8 may be integrally provided at the base plate 5 at which the door lock striker 1 is provided or may be integrally provided at the vehicle body panel B.

In the foregoing explanation, the embodiment is employed in the side door of the vehicle having the structure of the open air car or in the vehicle having the structure of the convertible vehicle (that is, the vehicle provided with a roof that opens and closes, or with a removable roof). However, the embodiment may be employed in other doors for opening and closing an opening portion provided at the vehicle body, including but not limited to, a side door of a vehicle having a fixed roof, a sliding-type side door for sliding in a front/rear direction of the vehicle, a back door (a rear gate) for tilting in a vertical direction or a right/left direction of the vehicle to open and close an opening provided at a rear portion of the vehicle body.

According to the embodiment, the movable wedge device 2 of the vehicle door fixing apparatus includes the base plate 5 configured to be fixedly attached to one of the vehicle body panel B and the door panel D, the movable wedge 6 slidably provided at the base plate 5 and configured to be provided at the one of the vehicle body panel B and the door panel D. The movable wedge 6 is configured to be structured to be pushed against the fixed wedge 8, 27 configured to be provided at the other one of the vehicle body panel B and the door panel D. The movable wedge device 2 of the vehicle door fixing apparatus also includes the biasing member 12 provided to be positioned between the base plate 5 and the movable wedge 6 and biasing the movable wedge 6 toward the fixed wedge 8, 27, the guide rail 11 provided at one of the base plate 5 and the movable wedge 6, the guide groove 10 which is provided at the other one of the base plate 5 and the movable wedge 6, and with which the guide rail 11 engages for allowing the movable wedge 6 to slide, and the leaf spring 13, 30 or the protrusion 18, 19 provided in the compressed state between the surface of the guide rail 11 and the wall of the guide groove 10.

Consequently, according to the movable wedge device 2 including the rail mechanism constituted by the guide groove 10 and the guide rail 11, the movable wedge 6 slides appropriately by causing the guide rail 11 to slide along the guide groove 10. However, the backlash of the movable wedge 6 may be caused by the looseness between the guide groove 10 and the guide rail 11, and thus the movable wedge 6 is displaced and collides with the guide rail 11 or with the fixed wedge 8 in a state where the door is closed, thereby possibly causing the abnormal noise.

By providing the leaf spring 13, 30 or the protrusion 18, 19 in the compressed state between the wall of the guide groove 10 and the surface of the guide rail 11, the surface of the guide rail 11 is pushed against the wall of the guide groove 10 by the leaf spring 13, 30 or the protrusion 18, 19. Thus, the looseness between the guide rail 11 and the guide groove 10 is reduced, and thus the backlash of the movable wedge 6 may be restricted. Consequently, the occurrence of the abnormal noise may be appropriately restricted.

According to the embodiment, the movable wedge device 2 of the vehicle door fixing apparatus further includes the door lock striker 1 provided at the base plate 5.

Consequently, the movable wedge 6 and the door lock striker 1 may be assembled on the vehicle body panel B at the same time, thereby improving the working performance for the assembly.

According to the embodiment, the elastic member 13, 30 is the leaf spring 13, 30.

Consequently, the surface of the guide rail 11 is pushed against the wall of the guide groove 10 by the leaf spring 13, 30. Thus, the looseness between the guide rail 11 and the guide groove 10 is reduced, and thus the backlash of the movable wedge 6 may be restricted. Consequently, the occurrence of the abnormal noise due to the backlash may be appropriately restricted.

According to the embodiment, the leaf spring 13 is made from metal and is insert-molded to the movable wedge 6 made of resin.

Consequently, the leaf spring 13 made from metal may be provided at the movable wedge 6 in the simple and accurate manner.

According to the embodiment, the leaf spring 30 is made of resin and is formed to be integral with the movable wedge 6 made of resin.

Consequently, the leaf spring 30 is formed during the molding process of the movable wedge 6 so as to be integral with the movable wedge 6.

According to the embodiment, the vehicle door fixing apparatus includes the base plate 5 configured to be provided at one of the vehicle body panel B and the door panel D, the fixed wedge 8, 27 configured to be fixedly attached to the other one of the vehicle body panel B and the door panel D, the movable wedge 6 slidably provided at the base plate 5, the biasing member 12 provided to be positioned between the base plate 5 and the movable wedge 6 and biasing the movable wedge 6 toward the fixed wedge 8, 27, the guide rail 11 provided at one of the base plate 5 and the movable wedge 6, the guide groove 10 which is provided at the other one of the base plate 5 and the movable wedge 6, and with which the guide rail 11 engages for allowing the movable wedge 6 to slide, and the leaf spring 13, 30 or the protrusion 18, 19 provided in the compressed state between the surface of the guide rail 11 and the wall of the guide groove 10.

Consequently, according to the vehicle door fixing apparatus including the rail mechanism constituted by the guide groove 10 and the guide rail 11, the movable wedge 6 slides appropriately by causing the guide rail 11 to slide along the guide groove 10. However, the backlash of the movable wedge 6 may be caused by the looseness between the guide groove 10 and the guide rail 11, and thus the movable wedge 6 is displaced and collides with the guide rail 11 or with the fixed wedge 8 in a state where the door is closed, thereby possibly causing the abnormal noise.

By providing the leaf spring 13, 30 or the protrusion 18, 19 in the compressed state between the wall of the guide groove 10 and the surface of the guide rail 11, the surface of the guide rail 11 is pushed against the wall of the guide groove 10 by the leaf spring 13, 30 or the protrusion 18, 19. Thus, the looseness between the guide rail 11 and the guide groove 10 is reduced, and thus the backlash of the movable wedge 6 may be restricted. Consequently, the occurrence of the abnormal noise may be appropriately restricted.

According to the embodiment, the vehicle door fixing apparatus further includes the door lock striker 1 provided at the base plate 5.

Consequently, the movable wedge 6 and the door lock striker 1 may be assembled on the vehicle body panel B at the same time, thereby improving the working performance for the assembly.

According to the embodiment, the elastic member 13, 30 is the leaf spring 13, 30.

Consequently, the surface of the guide rail 11 is pushed against the wall of the guide groove 10 by the leaf spring 13, 30. Thus, the looseness between the guide rail 11 and the guide groove 10 is reduced, and thus the backlash of the movable wedge 6 may be restricted. Consequently, the occurrence of the abnormal noise due to the backlash may be appropriately restricted.

According to the embodiment, the leaf spring 13 is made from metal and is insert-molded to the movable wedge 6 made of resin.

Consequently, the leaf spring 13 made from metal may be provided at the movable wedge 6 in the simple and accurate manner.

According to the embodiment, the leaf spring 30 is made of resin and is formed to be integral with the movable wedge 6 made of resin.

Consequently, the leaf spring 30 is formed during the molding process of the movable wedge 6 so as to be integral with the movable wedge 6.

According to the embodiment, the abnormal noise caused by the backlash of the movable wedge may be appropriately restricted.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A movable wedge device of a vehicle door fixing apparatus, comprising:
a base plate configured to be fixedly attached to one of a vehicle body panel and a door panel;
a movable wedge slidably provided at the base plate and configured to be provided at said one of the vehicle body panel and the door panel, the movable wedge being configured to be structured to be pushed against a fixed wedge configured to be provided at the other one of the vehicle body panel and the door panel;
a biasing member provided to be positioned between the base plate and the movable wedge and biasing the movable wedge toward the fixed wedge;
a guide rail provided at one of the base plate and the movable wedge;
a guide groove which is provided at the other one of the base plate and the movable wedge, and with which the guide rail engages for allowing the movable wedge to slide; and
an elastic member provided in a compressed state between a surface of the guide rail and a wall of the guide groove.

2. The movable wedge device of the vehicle door fixing apparatus according to claim 1, further comprising:
a door lock striker provided at the base plate.

3. The movable wedge device of the vehicle door fixing apparatus according to claim 1, wherein the elastic member is a leaf spring.

4. The movable wedge device of the vehicle door fixing apparatus according to claim 3, wherein the leaf spring is made from metal and is insert-molded to the movable wedge made of resin.

5. The movable wedge device of the vehicle door fixing apparatus according to claim 3, wherein the leaf spring is made of resin and is formed to be integral with the movable wedge made of resin.

6. A vehicle door fixing apparatus, comprising:
a base plate configured to be provided at one of a vehicle body panel and a door panel;
a fixed wedge configured to be fixedly attached to the other one of the vehicle body panel and the door panel;
a movable wedge slidably provided at the base plate;
a biasing member provided to be positioned between the base plate and the movable wedge and biasing the movable wedge toward the fixed wedge;
a guide rail provided at one of the base plate and the movable wedge;
a guide groove which is provided at the other one of the base plate and the movable wedge, and with which the guide rail engages for allowing the movable wedge to slide; and
an elastic member provided in a compressed state between a surface of the guide rail and a wall of the guide groove.

7. The vehicle door fixing apparatus according to claim 6, further comprising:
a door lock striker provided at the base plate.

8. The vehicle door fixing apparatus according to claim 6, wherein the elastic member is a leaf spring.

9. The vehicle door fixing apparatus according to claim 8, wherein the leaf spring is made from metal and is insert-molded to the movable wedge made of resin.

10. The vehicle door fixing apparatus according to claim 8, wherein the leaf spring is made of resin and is formed to be integral with the movable wedge made of resin.
